(19) United States
(12) Patent Application Publication
(10) Pub. No.: US 2002/0198862 A1
(43) Pub. Date: Dec. 26, 2002

(54) Method for processing request and request processing system

(76) Inventor: Matthias Bellmann, Icking (DE)

Correspondence Address: BELL, BOYD & LLOYD, LLC, P. O. BOX 1135, CHICAGO, IL, 60690-1135, US

(21) Appl. No.: 10/110,603

(22) PCT Filed: May 31, 2001
(86) PCT No.: PCT/EP01/06213

(30) Foreign Application Priority Data
Aug. 11, 2000 (EP) 00117489.5

(51) Int. Cl. G06F 17/00; G06F 17/30; G06F 7/00

(52) U.S. Cl. 707/1; 707/104.1

(57) ABSTRACT

For processing inquiries from customers, cooperating parties, employees or other people at institutions having a multiplicity of operatives who are potentially competent to process such inquiries, a method is proposed in which incoming inquiries are, provided that they are not already in digital form as an e-mail or an electronically stored text, digitized and are stored in digital form, and these inquiries stored in digital form are made available to possible operatives for such inquiries in the form of an electronic database over a network.

The invention relates to a method for processing inquiries using a multiplicity of operatives who are potentially competent to process such inquiries.

To communicate with customers, cooperating parties, employees or other people, commercial enterprises, authorities, associations and other institutions having a multiplicity of operatives who are potentially competent to process such inquiries normally use “call centers” today. These call centers have the advantage of particularly satisfying the needs of people who value a human interlocutor. However, experience shows that written communication is in many cases more appropriate and more effective than a personal conversation, because it can take place at a later time and presentation of complicated facts is often facilitated.

Particularly in cases in which the question of competence within the institution cannot be clarified until the inquiry is available, communication by telephone is often a waste of time and inefficient. The frequent drawback of written communication is that written inquiries are often not dealt with for a long time and in many cases their route through the institution can be reconstructed only with difficulty. Dissatisfaction or lost business opportunities are the consequences which are often detrimental to commercial enterprises.

The complexity of large enterprises means that they become confusing to the individual to some extent, as a result of which inquiries and problems are frequently a number of times separately. This redundant processing means a loss of efficiency in the enterprise as the size of the enterprise increases.

It is therefore an object of the invention to provide an EDP-assisted system (inquiry processing system) which improves effectiveness again. In addition, an appropriate method also needs to be described. This object is achieved by the independent patent claims. Advantageous developments of the invention are the subject matter of subordinate claims.

Accordingly, the inventor proposes developing further a method for the, at least partially automatic, processing of inquiries, using a multiplicity of operatives who are potentially competent to process such inquiries, having at least the following steps: incoming inquiries are, provided that they are not already in digital form, digitized (digital inquiry) and are stored in digital form, and the digital inquiry is made available to potential operatives in the form of an electronic database over a network. In the last step, after the digital inquiry has been processed, this digital inquiry is concluded.

In one advantageous embodiment of the inventive method, the digital inquiry is deposited in the electronic database, which contains a multiplicity of tables and fields, and is assigned to at least one table. The electronic database is used for the central supply of data, with the tables being linked to one another, at least in part.

In another advantageous embodiment, responses can be stored in the electronic database and can be associated with digital inquiries, and if a digital inquiry arises which has an associated response in the electronic database, this associated response is automatically output as a standard response. There is thus an automatic check to determine whether there is already a standard response available, for example in a “Response” database table, for a question which has been received. If this is the case, the standard response can be sent back to the inquiring customer without involving other operatives or experts. Since approximately 80% of customer inquiries concentrate on approximately 20% of the available topics, this achieves an enormous time saving and effectiveness.

If addition, the standard response can include the opportunity for the customer to respond back. By way of example, the customer can be asked whether it has been possible to solve his problem using the response which was output, or is asked to assess the quality of the response. The assessments can be shown alongside the response times of the individual operatives or teams on various statistics.

In one advantageous development, the inventive method provides the opportunity for a customer to respond back to a received response or to a received interim report (e-mail reply) and for this customer-response e-mail to be automatically entered into the database such that the customer response is entered in the appropriate team under the original question as an action by the customer (for example called “response from the customer”), and no “new” question is created.

In another development, the digital inquiry is analyzed in the electronic database, preferably for prescribed keywords, and is assigned to at least one of the operatives on the basis of the prescribed keywords. Preferably, the keywords in a digital inquiry are assigned to at least one prescribed topic. The subjects linked to the keywords are counted and, if over 50% of an individual topic arises, are automatically assigned to at least one of the operatives using the electronic database. Otherwise, if over 50% of any topic is not covered, a receiving operative preferably receives a list of the frequency of all the topics covered, with the receiving operative then making a manual assignment to at least one of the operatives. The percentage at which automatic assignment takes place can be set (configured), for example to over 60%. This percentage expresses what the minimum probability should be for a topic, after counting, in order for the inquiry to be assigned clearly. As an example, a keyword assignment yields the topics “Legal” and “International”, with the topic “Legal” appearing twice and the topic “international” appearing once. If the percentage is configured to be [symbol] 60, the inquiry is assigned to the topic “Legal”, and then to an operative who has been assigned for this topic.

The inventive method can provide a further configuration parameter which indicates the minimum number of hits a topic should have in order for it to be able to be chosen as the topic. It is thus possible to choose for a topic to need to have at least four hits before it is accepted as the topic. For the above example with the topics “International” and “Legal”, this means that an inquiry is not assigned to the topic “Legal” until there are at least four hits for the topic “International” and, by way of example, two hits for the topic “Legal”.

If no clear result is yielded for an inquiry or if there are spelling mistakes in the inquiry, this inquiry can be assigned to a topic “unknown topic”, for example, in order to allow the receiving operative to take a manual decision.

In one advantageous embodiment of the inventive method, at least one receiving operative can check the incoming inquiry determine whether processing using an automatic standard process, for example a standard response, is possible, and, if so, on the basis of the result of this check, such an inquiry is processed using the standard process, or this inquiry is assigned to at least one operative for further processing.

In another development, a digital inquiry is concluded by marking it as processed or archiving it or deleting it. Thus, an archive database can be used for the archiving.

In addition, a processing status, a processing history for the inquiry or other operational information can be stored in the electronic database together with the digital inquiry, and it should be possible to access these at any time. Operational information can, by way of example, be information relating to competences or problems which have arisen in connection with the inquiry. The processing status of an inquiry can indicate whether the inquiry is being processed at the current time. The processing history reveals who has done what when, that is to say which operative has processed which inquiry at what time and for how long and has possibly created notes and interim reports or has asked queries of colleagues.

In another advantageous embodiment of the inventive method, precisely one operative can process the digital inquiry at the same time. Preferably, this inquiry is displayed to all other operatives as blocked.

In addition, the inquiries can be stored, preferably in the form of HTML documents, in an intranet database, with the inquiries being processed by producing and sending an e-mail addressed to the inquirer (response e-mail). In this case, this response e-mail which has been produced can have other information added to it, such as attachments, http links and particular formatting. A response e-mail to the customer should provide the opportunity to assess the quality of the experts' response. This is achieved by means of a link to an assessment page in each response e-mail. The customer's assessment is stored in the database.

The customer can use his normal e-mail program for his inquiries, which means that he too can append attachments to his e-mail.

In each processing step, the changed processing status or the competence for further processing can be changed. This means that even a geographically spread team of operatives, such as is the case with a large company having various locations, can efficiently collaborate in processing inquiries, which significantly reduces the processing time for the inquirer. In addition, the inventive method makes it possible to prevent the same inquiry, put to different locations, from being answered separately in each case, so that it is also possible to achieve a time saving for the operatives.

In another development of the inventive method, at least one privileged operative can use a database function to make statistical requests. In addition, it is advantageous if such statistical requests are automatically updated and their results are made available to at least one privileged operative. A superior or an operative privileged in another way can thus continually monitor the status of processing by means of statistical requests and, if necessary, can intervene in a controlling capacity.

One advantageous extension of the inventive method provides for the inclusion of SMS (Short Message Service), WAP (Wireless Application Protocol) or UMTS (Universal Mobile Telecommunications System), so that the customers are provided with access to the system via mobile terminals as well.

The inventor also proposes an inquiry processing system for processing incoming inquiries, having at least an AD converter which converts the inquiries, provided that they are not already in digital form, into digital inquiries, an electronic storage medium for storing the digital inquiries, an electronic database which has a multiplicity of tables and fields, a multiplicity of potentially competent operatives, a network which connects at least the operatives and the electronic database to one another, and a distribution means which automatically assigns, at least some of, the digital inquiries to at least one of the operatives.

In one particularly advantageous embodiment of the inventive inquiry processing system, the distribution means contains at least one program or a program module for carrying out the inventive method.

In addition, the distribution means can be designed such that it assigns the digital inquiry to at least one of the tables in the electronic database. The database is used for the central supply of data, for example for a service of the inquiry processing system, for an expert application, for an assessment application for the customer, and for assessment and statistical evaluations. A suitable database is any relational database system, for example Microsoft SQL Server, MySQL Server, DB2, etc.

In one development of the inquiry processing system, the distribution means is designed such that it outputs a standard response.

The invention is described in more detail below using preferred exemplary embodiments and with reference to the figures, in which:

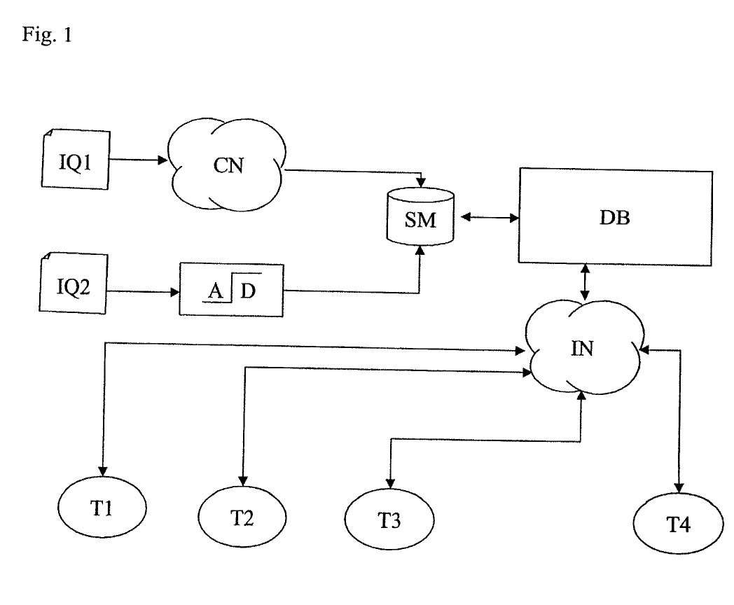

FIG. 1 shows a schematic illustration of the inquiry processing system for carrying out the inventive method;

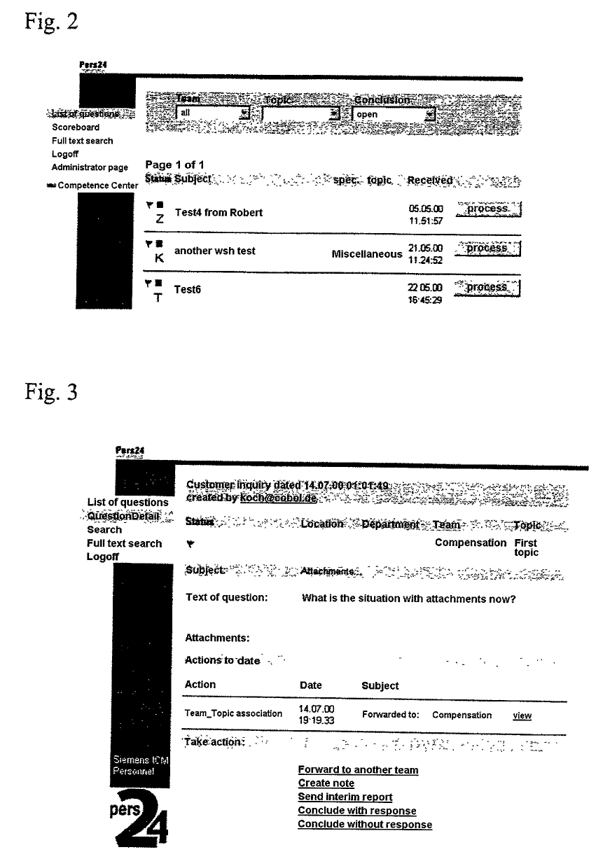

FIG. 2 shows an interface for the “List of questions” page;

FIG. 3 shows an interface for the “QuestionDetail” page;

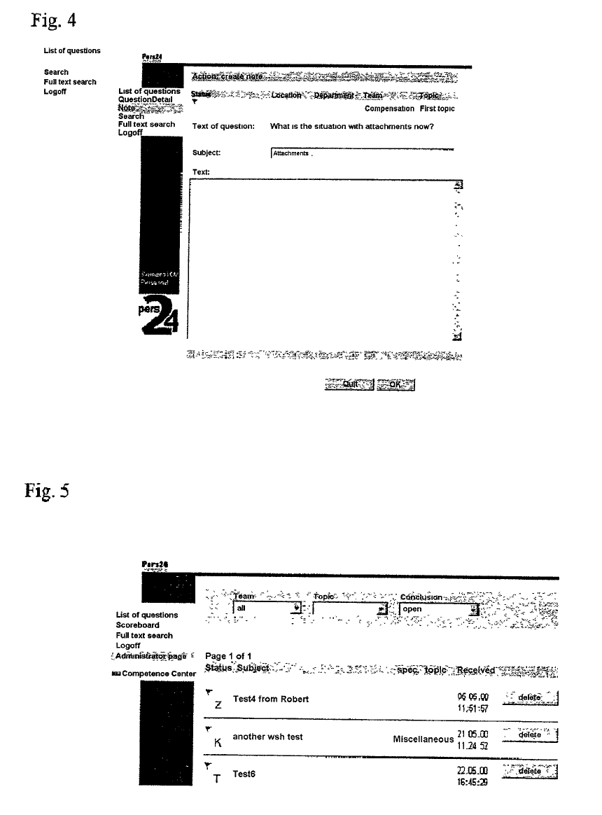

FIG. 4 shows an interface for the “Note” page;

FIG. 5 shows an interface for the “Administrator page” page.

FIG. 1 shows a schematic illustration of a preferred exemplary embodiment of the inventive method.

Inquiries IQ1 and IQ2 arrive on an electronic storage medium SM via a communications network CN, that is to say, by way of example, as an e-mail IQ1 over the Internet, or are received, by way of example, as paper documents IQ2 and are digitized by an A/D converter, such as a scanner AD, and are then stored on the electronic storage medium SM. In addition, the A/D converter can also be in the form of a voice recognition system which converts the inquiries received by telephone into digital documents IQdig. The inquiries IQdig stored on the electronic storage medium SM are deposited in an electronic database DB and are made available to possible operatives T1 . . . T4 over a network IN.

This is preferably done by converting the inquiries IQdig stored in digital form into HTML documents and incorporating them in an intranet database DB. This database DB stores the inquiries together with other information, such as the processing status of the inquiry, its processing history, or together with information about competences for processing, problems arising and similar information.

In each processing step, the processing status or the competence for further processing can be changed. This means that even a geographically spread team of operatives can efficiently collaborate in processing inquiries, which significantly reduces the processing time for the inquirer. A superior or an operative privileged in another way can continually monitor the status of processing by means of statistical requests and, if necessary, can intervene in a controlling capacity.

After a certain degree of complexity in the system, it will be worth providing a receiving operative or even a whole team of receiving operatives, whose task is to check incoming inquiries to determine whether processing using a standard process is possible and, on the basis of the result of this check, to prompt the use of the corresponding standard process or otherwise to assign this inquiry to a specialized operative or even to a team of specialized operatives for further processing. This hierarchy can also be used on a plurality of levels if the complexity of the overall process makes this seem appropriate.

To implement these method procedures at a technical level, the operatives T1 . . . T4 can be networked to the electronic database DB in an appropriate manner, for example over an intranet IN. All the HTML documents are available to all the appropriate, that is to say potentially competent, operatives or all the operatives in a competent team for viewing and for processing. An inquiry which has been processed fully can be correspondingly marked, archived or else fully deleted.

A process running in the background of the system automatically converts incoming inquiries into HTML documents and incorporates them in the database. If there is a receiving operative, he examines the documents and assigns them to specialized operatives for further processing. These inquiries then become visible to the selected specialized operatives. In this way, preferably only those inquiries for which an operative is actually competent on account of his specialization are displayed to each operative by the system as inquiries which he needs to process. This mechanism is implemented by means of appropriate database entries whose content is used by the system for the purpose of selectively displaying inquiries or database records on the basis of the competence or specialization of the operative.

The use of the HTML data format provides implementation of the present invention with the advantage of being independent of operating system and hardware platform, which particularly in regionally spread or global networks is a fundamental prerequisite for the inquiries to be processed by local but geographically widespread teams of operatives used according to technical specialization. For the same reason, it is advantageous to make these HTML documents available to the operatives in an intranet database over an intranet. In this way, it is possible, above all, to guarantee the smooth collaboration of operatives in different countries with different hardware equipment within a team.

The text below gives a detailed description of the inventive method and of the use of the inventive inquiry processing system.

This is a system of programs which a customer, for example an employee in a large enterprise, can use to pose a problem to a server by means of a question via e-mail. On the server, this question is dispatched, that is to say forwarded to the first most suitable team of experts, automatically or with the aid of an experienced user. By way of example, in the case of a personal question relating to a foreign visit planned by the employee, the automatic or manual dispatcher should recognize that the customer inquiry is forwarded to the Personal/International team.

The automatic dispatch process is transparent for all the users of the inquiry processing system (both for the customer and for the expert). Manual forwarding is effected using an expert application, in which the manual dispatcher is also classified as an expert. This “dispatch” process is called team/topic association. During the dispatch process, all the information in the original e-mail (subject, text, attachments, formatting) is already available. As the result of this process, the question is shown in the list of questions (or else workdesk) for the team of experts.

The expert can now take various actions, for example conclude with an e-mail to the customer, conclude without an e-mail to the customer, an interim report, a note, forward to another team.

Besides having other characteristics, the inquiry processing system is a workflow application. However, the workflow is not completely freely configurable, but rather is tuned specifically to the depiction of a virtual helpdesk system. The workflow presents itself to the user (=expert) as an HTML interface. The automated stations in the workflow can be implemented as an NT service or Unix Daemon (depending on the target platform used).

A prerequisite of the inventive inquiry processing system is an available POP server (for example Exchange Server). This computer receives the message (e-mail) sent by the customer from the Internet and deposits it in a mailbox. Installed on a server is a service of the inquiry processing system. This service polls from this mailbox using a continuous loop. The service reads all the components of the e-mails which are in the mailbox, such as sender, attachments, formatting. It is possible to configure this service for, by way of example, how often polling occurs, which mailboxes are polled, what happens to messages which are read (for example delete from POP, mark as read in POP, etc.). Unreadable messages can preferably trigger an e-mail to the administrator of the inquiry processing system.

The distributor for the inquiries/messages received is an automated or manual workflow station. The result of distribution is a topic assignment. Following distribution, the question exists as a question data record in the database. This question is preferably assigned to a subject. If appropriate, a team or to an operative has likewise already been firmly assigned.

In rare cases, the question is actually answered immediately by the manual or automatic dispatcher. The question is then considered to have been concluded. From the time “start of distribution”, the question ages up to a concluding action (as described below). The message is now examined. This can involve checking whether the message is a reply to a previously sent response to an earlier question from the customer. If this is not the case, the message (subject and text) can be checked for keywords from the database. These keywords are held in the database and can be associated with various topics. From the database, the inquiry processing system's service reads which topics have been touched upon in a message and how often. In the service's configuration, the percentage then represents the probability which will be accepted for assigning a message to a particular topic. This number should be greater than 50. It expresses the minimum probability which a topic should have, after the topics have been counted, for the purpose of clearly assigning the message.

This decision algorithm provides a further configuration parameter, which indicates the minimum number of hits a topic should have in order to be able to be chosen as the topic. If the algorithm does not yield a clear result for a message, or if automatic dispatching is turned off in the service configuration, the service alternatively assigns the received message to the topic “unknown topic” in order to allow a manual decision. The topic “unknown topic” is hard coded in the inquiry processing system. If topic assignment has taken place, the message is stored in the database with attachments as a new question or as the action “response from customer” for an earlier question.

Both manual distribution and the entire application are an ASP application which produces pure HTML (DHTML) code. The term ASP application is understood generally as web server scripting on the server. Instead of the Microsoft technology “Active Server Pages”, it is likewise possible to use CGI scripting and PHP3/4, for example. This HTML needs to be made as browser-independent as possible (Microsoft Internet Explorer, Netscape Navigator, etc.). Logging onto the page is preferably effected using Basic (IE: Challenge Response) Authentication. This allows access to the logged-on user name (expert name) on the server page (for example Microsoft Internet Information Server: Request.ServerVariables (“LOGON_USER”)). This user name is then compared with entries in the “Experts” table.

FIG. 3 shows an exemplary embodiment of the “List of questions” interface. In this case, three received questions are shown and also a multiplicity of buttons, which are self explanatory and are thus not described in any more detail. To trigger an action, the expert (the operative) first opens the inquiry on the workdesk using the “process” button associated with the corresponding inquiry.

A new interface then appears, the “QuestionDetail” page, shown in FIG. 4. This page preferably shows the actions to date. There is also the opportunity to initiate new actions. In this context, it is important for the question to be a question associated with the team which includes the logged-on expert, in this exemplary embodiment the “Compensation” team. This can be symbolized by different colors, for example a green box means “question from my team”, whereas a red box means “question from another team—I can only view it and can initiate no new actions for this question”.

The “Attachments” block contains HTML “download” links (one for each attachment) which allow the expert to download or open the chosen attachment.

The color of the status of an inquiry is also significant. This involves a configurable “traffic light system”. In this regard, three values are recorded in the configuration (for Microsoft IIS, for example the registry of the Internet Information Server) of the Internet server on which the expert application is running:

1. maximum time green (x hours)

2. maximum time yellow (y hours)

3. maximum time red (z hours)

These three values indicate when a question which has not yet been concluded adopts which “flag color”. The expert application should ensure that only one expert can ever process a question at the same time, that is to say only one expert can initiate actions in the QuestionDetail page. The question should be displayed to all the other experts (including on the same team) as blocked in the list of questions (in FIG. 2).

In the case of ASP and Microsoft Internet Information Server, it is possible for an expert viewing a question in detail to use ASP to store his IIS SessionID (Microsoft: Session.SessionID) in the database (Question.SessionID) for this question. As soon as he leaves a question, he enters zero again in the question SessionID and another expert can process the question further. This method is preferable over database-internal blocking mechanisms, since database-internal blocking mechanisms take up too many resources on the database server during asynchronous communication between client (browser) and server (web server).

In one advantageous embodiment, the “Take action” block in the “QuestionDetails” interface will be blanked out (no HTML is produced for this block) if the question is not associated with the team. The individual actions in this block are described more precisely below:

The action “Forward to another team” allows the expert to forward the question to another team and/or to assign this question to another team.

The action “Interim report” can be started at any time. Interim reports are preferably transmitted to the poser of the question (customer) as an e-mail. Interim reports have the input fields Subject and Customer's e-mail address to which the interim report and text are sent. In addition, a wizard can be used to append attachments to the interim report. Otherwise, interim reports are no different than notes, which is shown in FIG. 4. Attachments can be appended to the message HTTP Multiform Upload. The e-mail to the customer is created on the Internet server and sent when the expert clicks on “send”. Microsoft NT Server allows the use of the library cdonts.dll and of the Microsoft SMTP servers. Just like the one for “Conclude with response”, the sender address in the interim report is preferably always the inquiry processing system's e-mail account which the customer also used when the question was posed originally. This gives the inquiry processing system's service the opportunity to parse (break down) any response (reply) from the customer to the interim report in order to associate this reply with the original question again.

The action “Query to colleague”, which is not actually shown in FIG. 3 in the “Take actions” block, is used to send a question to a colleague so that the “Conclude with response” can later be performed successfully using the colleague's response. The query permits appending of attachments and storage as a draft. In the event of storage as a draft, the list of actions later preferably contains “Draft: query to colleague”. If the user (expert) later opens this draft again, he can process it further and then send it or store it as a draft again. Preferably, only one “Draft: query to colleague” action can exist per question.

The sender address used for the message which is likewise produced on the inquiry processing system's Internet server is a configured mailbox which exists in addition to the standard account. A reply from the colleague can be classified by a second “Configured service instance” for the service. This means that the service has the opportunity to poll a second mailbox and to identify everything which takes place there as a “reply from colleague” without parsing. It should be pointed out to the colleague, as to the customer, in the e-mail that, by way of example, the subject of the response (customer/colleague reply) to the e-mail produced (for example Interim report, Conclude with response, Query to colleague) cannot be altered if the subject of the inquiry processing system's e-mail produced contains a question ID, for example a headword, which the service uses as a basis for parsing.

One example of the configuration of the service instances is as follows:

REGEDIT4
[HKEY_LOCAL_MACHINE\SOFTWARE\MVI\P24\MailProcessor]
@=“0”
“SendUndeliverableTo”=“carsten.nitzpon@mch.siemens.de”
“LogEvents”=“1”
“WaitBetweenProcessing”=“10”
“InstanceCount”=“1”
[HKEY_LOCAL_MACHINE\SOFTWARE\MVI\P24MailProcessor\
Instance1]
“MAPIProfileName”=“P24Service”
“SQLOLEDB”=“Provider=SQLOLEDB;uid=sa;pwqd=;Server=Borde
aux;
Database=P24”
“QuestionTable”=“tbl_question”
“AnswerTable”=“tbl_actions”
“AttachmentTable”=“tbl_question_attachment”
“DeleteProcessedMail”=“0”
[HKEY_LOCAL_MACHINE\SOFTWARE\MVI\P24MailProcessor\
Instance2]
“MAPIProfileName”=“P24Service ExpertReply”
“SQLOLEDB”=“Provider=SQLOLEDB;uid=sa;pwqd=;Server=Borde
aux;
Database=P24”
“QuestionTable”=“tbl_ExpertReply” (This table needs to
be created from the administration application when
required!)
“AttachmentTable”=“tbl_ExpertReply_Attachments” (this
table needs to be created from the administration
application when required!)
“DeleteProcessedMail”=“0”

In addition, the action “Conclude with response” can be provided. In principle, this action likewise sends an e-mail to the customer (see “Interim report” action) However, from the time of this action, the question is considered to have been concluded (that is to say this response does now not age any further on the basis of the flag color).

If the question is opened again, following conclusion, by one of the following actions:

Response from customer

Assessment by customer,

the flag color again corresponds to the period of time which has elapsed since the “reopening” up to now (time of consideration). The expert's earlier reaction time can still be taken from the database, however (all actions with date/time are maintained), which means that this earlier reaction time can still be evaluated statistically. “Conclude with response” can likewise be stored as a “draft” (see Query to colleague).

The action “Conclude without response” concludes a question, but without generating an e-mail to the customer. This is useful when the expert contacts the customer by telephone to solve a problem. The content of this action corresponds to that of a note.

In addition, the “QuestionDetail” interface in the inquiry processing system permits a search and a full text search as lookup options for experts while searching for the correct response to this customer question. The search opens a page having a list of questions which have already been concluded regarding the same topic (across teams), sorted in descending order based on the date/time of the last action. In this case, the expert can view all the actions which have been taken in relation to these questions. A “Transfer” button exists preferably for “Conclude with response” actions which are sought, which allows both the attachments and the text of the response to be transferred. The search takes place in a new browser window. An expert can search only if he is processing a question.

The full text search allows any expert to search the keywords, across topics and teams, both in subjects and texts of questions and in subjects and texts of actions (in each case with a selection option). This is likewise done in a new browser window and can be retrieved at any point in the expert application.

An expert response is assessed by the customer using an ASP page which the customer can call up by clicking on a link automatically produced in the expert response e-mail. This link contains, among other things, a query string (HTML) (question poser's e-mail, question ID) which the ASP page can use to make sure that the assessment is actually made by the correct customer. The assessment page can allow the expert response to be assessed using a school grades system and the writing of a comment.

The text below gives an exemplary embodiment of the database in the inventive inquiry processing system. Relationships described by foreign keys (FK) are seen as hard (NOT NULL) restrictions on the relational database systems. Exceptions are identified separately.

The database preferably contains the tables listed below. The fields in the tables are self explanatory on the basis of their name.

a) Topic

This table shows the topics. Topics are managed (created, changed) by an administration application

Fields:

TopicID (PK=Primary Key)

TopicDescription

b) Keywords

This records the keywords which the service compares with the message content (subject, text) in order to be able to make automatic assignments to topics. Keywords are managed (created, changed) by the administration application

Fields:

KeywordID (PK)

Keyword

c) Teams

This records the teams. Teams are managed (created, changed) by the administration application. Teams are used primarily for selecting the questions on a workdesk. Not every team member (operative) has his own workdesk. Every operative works in the workdesk of his team. This table is managed (created, changed, deleted) by the administration application.

Fields:

TeamID (PK)

TeamName

d) Team/Topic Association

This table permits the n:m relationship between teams and topics. A plurality of teams can be assigned to a plurality of topics, and vice versa. This table is managed (created, changed, deleted) by the administration application. It is used exclusively to determine the choice of teams which an expert has when he has selected a topic for the team/topic association action.

Fields:

TeamTopicAssociationID (PK)

TeamID (FK=Foreign Key, Team table)

TopicID (FK, Topic table)

e) Topic/Keyword Association

This table is used by the service's algorithm for counting the hits when automatically classifying an incoming message for the desired topic. This table is managed (created, changed, deleted) by the administration application. Alternatively, this table is maintained by the teams themselves. However, only the keywords which are associated with the processing expert's team can be maintained for a topic.

Fields:

TopicKeywordAssociationID (PK)

TeamID (FK, Team)

TopicID (FK, Topic table)

f) Experts

This table is used primarily by the users for the purpose of individual logging on. In principle, it is also possible for each team to contain only one “expert” and for all the members of the team to log on using the same expert name. The expert application contains sufficient mechanisms used to prevent questions from being processed simultaneously by different team members. This table is managed (created, changed, deleted) by the administration application

Fields:

ExpertsID (PK)

TeamID (FK, Team table)

Username

Password (encrypted, e.g. password( . . . )) function in MySQL or a separate implementation within the database management system (DBMS)

g) Questions

In this table, the service stores the incoming new questions. A new data record in this table is the “initial trigger” for a new, independent process. The administration application can be used to remove questions completely from the database or to move them to an archive database (in each case including all the dependent actions and attachments).

Fields:

QuestionID (PK)

TopicID (FK, Topic table)

TeamID (FK, Team table, NULL is permitted)

CustomerE-mailAddress

QuestionSubject

QuestionText

QuestionDateTimeGMT

Read-inDateTimeGMT

h) Types of Action

This table stores the types of action, for example Conclude, Interim report, Query to colleague, etc. This table is managed (created, changed, deleted) by the administration application.

Fields:

Action typeID (PK)

Action description

ActionWithResponseToCustomer (Yes/No)

i) Actions

This table stores the actions initiated by experts and customers. Actions are always assigned to precisely one question.

Fields:

ActionID (PK)

Action typeID (FK, Types of action table)

QuestionID (FK, Questions table)

ActionDateTimeGMT

ActionReceiverE-mailAddress (already used by Questions.CustomerE-mailAddress)

ActionSubject (already used by Questions.QuestionSubject)

ActionText

j) QuestionsAttachments

This stores the e-mail attachments for the questions

Fields:

QuestionAttachmentID (PK)

QuestionID (FK, Questions table)

AttachmentBinary

k) ActionsAttachments

This stores the e-mail attachments for the actions

Fields:

ActionsAttachmentID (PK)

ActionID (FK, Questions table)

AttachmentBinary

FIG. 4 shows the interface for the “Note” page. A note comprises a subject field and a text field. The note has no external influence, but rather is used merely for storage in the inquiry processing system's workdesk. A note can preferably be created at any time.

FIG. 5 shows the interface for the “Administrator page”. The administration application makes it possible to parameterize the expert application and possibly the service of the inquiry processing system. In addition, the administration application permits questions to be deleted and archived. An archiving button should likewise be provided.

The administration application is likewise an ASP application. Logging on likewise takes place using “Basic Authentication” or “Challenge Response”. It ought to be ensured that only a single administrator is in the application at the same time. It is possible to block the administration application in a similar way to the blocking of a question.

It goes without saying that the features of the invention which are cited above can be used not only in the respective combination indicated, but also in other combinations or on their own without departing from the scope of the invention.

Overall, the invention provides an EDP-assisted system (inquiry processing system) which improves the effectiveness when processing inquiries. An appropriate method is also described.

1. A method for the, at least partially automatic, processing of inquiries (IQ1, IQ2), using a multiplicity of operatives (T1 . . . T4) who are potentially competent to process such inquiries (IQ1, IQ2), having at least the following steps:
a) incoming inquiries (IQ1, IQ2) are, provided that they are not already in digital form, digitized (digital inquiry (IQdig)) and are stored in digital form;
b) the digital inquiry (IQdig) is made available to possible operatives (T1 . . . T4) in the form of an electronic database (DB) over a network (IN);
c) after the digital inquiry (IQdig) has been processed, the digital inquiry is concluded.

2. The method as claimed in the preceding claim 1, characterized in that the digital inquiry (IQdig) is deposited in the electronic database (DB), which contains a multiplicity of tables and fields, and is assigned to at least one table.

3. The method as claimed in either of the preceding claims 1 and 2, characterized in that responses can be stored in the electronic database (DB) and can be associated with digital inquiries (IQdig), and if a digital inquiry (IQdig) arises which has an associated response in the electronic database (DB), this associated response is automatically output as a standard response.

4. The method as claimed in one of the preceding claims 1 to 3, characterized in that the digital inquiry (IQdig) is analyzed in the electronic database (DB), preferably for prescribed keywords, and is assigned to at least one of the operatives (T1 . . . T4) on the basis of the prescribed keywords.

5. The method as claimed in the preceding claim 4, characterized in that
a) the keywords in a digital inquiry (IQdig) are assigned to at lease one prescribed topic,
b) the topics linked to the keywords are counted, and
c) if over 50% of a topic arises, is automatically assigned to at least one of the operatives (T1 . . . T4) using the electronic database (DB),
d) otherwise a receiving operative preferably receives a list of the frequency of all the topics covered, and at least one of the operatives (T1 . . . T4) is assigned manually.

6. The method as claimed in one of the preceding claims 1 to 5, characterized in that at least one receiving operative
a) checks the incoming inquiries (IQ1, IQ2) to determine whether processing using an automatic standard process is possible, and, if so, on the basis of the result of this check,
b) such an inquiry is processed using the standard process, or
c) this inquiry is assigned to at least one operative (T1 . . . T4) for further processing.

7. The method as claimed in one of the preceding claims 1 to 6, characterized in that a digital inquiry (IQdig) is concluded by marking it as processed and/or archiving it and/or deleting it.

8. The method as claimed in one of the preceding claims 1 to 7, characterized in that a processing status and/or a processing history for the inquiry (IQ1, IQ2) and/or other operational information is stored in the electronic database (DB) together with the digital inquiry (IQdig).

9. The method as claimed in one of the preceding claims 1 to 8, characterized in that precisely one operative (T1) can process the digital inquiry (IQdig) at the same time.

10. The method as claimed in one of the preceding claims 1 to 9, characterized in that the inquiries (IQ1, IQ2) are stored in the form of HTML documents in an intranet database, with inquiries (IQ1, IQ2) being processed by producing and sending an e-mail addressed to the inquirer.

11. The method as claimed in one of the preceding claims 1 to 10, characterized in that at least one privileged operative can use a database function to make statistical requests, and/or in that such statistical requests are automatically updated and their results are made available to at least one privileged operative.

12. The method as claimed in one of the preceding claims 1 to 11, characterized in that the incoming inquiries (IQ1, IQ2) are made in the form of e-mail, SMS or using the WAP or UMTS.

13. An inquiry processing system for processing incoming inquiries (IQ1, IQ2), having at least
a) an AD converter which converts the inquiries (IQ1), IQ2), provided that they are not already in digital form, into digital inquiries (IQdig),
b) an electronic storage medium (SM) for storing the digital inquiries (IQdig),
c) an electronic database (DB) which has a multiplicity of tables and fields,
d) a multiplicity of potentially competent operatives (T1 . . . T4),
e) a network (IN) which connects at least the operatives (T1 . . . T4) and the electronic database (DB) to one another, and
f) a distribution means (VM) which automatically assigns, at least some of, the digital inquiries (IQdig) to at least one of the operatives (T1 . . . T4).

14. The inquiry processing system as claimed in the pr eceding claim 13, characterized in that the distribution means (VM) contains at least one program and/or a program module for carrying out the method as claimed in one of claims 1 to 12.

15. The inquiry processing system as claimed in either of the preceding claims 13 and 14, characterized in that the distribution means (VM) is designed such that it assigns the digital inquiry (IQdig) to at least one of the tables in the electronic database (DB).

16. The inquiry processing system as claimed in one of the preceding claims 13 to 15, characterized in that the distribution means (VM) is designed such that it outputs a standard response.
